(19) United States
(12) Patent Application Publication
(10) Pub. No.: US 2011/0138323 A1
(43) Pub. Date: Jun. 9, 2011

(54) Visual Indication Of Alarms On A Ventilator Graphical User Interface

(75) Inventors: John Skidmore, San Diego, CA (US); Mark Brecht, Imperial Beach, CA (US); Jim Fissel, Dallas, TX (US)

(73) Assignee: Nellcor Puritan Bennett LLC, Boulder, CO (US)

(21) Appl. No.: 12/631,685

(22) Filed: Dec. 4, 2009

(51) Int. Cl. G06F 3/048

(52) U.S. Cl. 715/800; 715/805; 715/802; 340/573.1; 715/846; 715/781

(57) ABSTRACT

Embodiments described herein seek to optimize the informative presentation of alarms on a ventilator user interface. Embodiments may provide a first level of display that provides a summary of an alarm event and, upon selection, a second level of display that provides additional detailed information regarding the alarm event. Further embodiments may provide access, via hyperlink or otherwise, to settings and/or display screens for resetting the alarm, for reconfiguring alarm settings as appropriate, or for gathering additional information regarding the alarm event. For multiple simultaneous alarm events, a plurality of alarm messages may be prioritized for a clinician on a designated area of the user interface. Prioritization may be communicated via the presentation of various icons, alerts, text, or otherwise, on individual alarm messages. Additionally or alternatively, prioritization may be communicated based on the graphical placement of alarm messages relative to other alarm messages, for instance by displaying more serious alarm messages above other alarm messages, or by displaying more recent alarm messages above other alarm messages. Additionally or alternatively, alarm messages may be partially translucent, such that other displayed respiratory data may be simultaneously viewed with the alarm messages.

### RELATED APPLICATIONS

This application is related to co-owned U.S. patent application Ser. No. ______, entitled “Visual Indication of Settings Changes on a Respiratory Ventilator Graphical User Interface”; U.S. patent application Ser. No. ______, entitled “Display and Access to Settings on a Respiratory Ventilator Graphical User Interface”; U.S. patent application Ser. No. ______, entitled “Display of Respiratory Data on a Ventilator Graphical User Interface”; and U.S. patent application Ser. No. ______, entitled “Quick Initiation of Respiratory Support via a Ventilator User Interface”; all filed on ______, the entire disclosures of all of which are hereby incorporated herein by reference.

### INTRODUCTION

A ventilator is a device that mechanically helps patients breathe by replacing some or all of the muscular effort required to inflate and deflate the lungs. During ventilation, the ventilator may be configured to generate various alarms upon detecting a change in the patient's condition, a malfunction of the ventilatory equipment, or other indication that clinician intervention may be warranted. Thus, alarms generally function to alert a clinician of an abnormal or unsafe condition that may impact the patient. In this sense, alarms are a very important and necessary feature of any therapeutic instrument. However, alarms may not convey enough information regarding whether, how, and when a clinician may need to intervene in the patient's treatment or to adjust the equipment. In addition, multiple simultaneous alarms may compound this insufficiency of alarm information, costing the clinician valuable time while deciding which alarm to address first.

### Visual Indication of Alarms on a Ventilator Graphical User Interface

This disclosure describes improved systems and methods for displaying alarms to a clinician in a ventilatory system. Specifically, embodiments described herein seek to optimize the informative presentation of alarms on a ventilator user interface. Embodiments may provide a first level of display that provides a summary of an alarm event and, upon selection, a second level of display that provides additional detailed information regarding the alarm event. Further embodiments may provide access, via hyperlink or otherwise, to settings and/or display screens for resetting the alarm, for reconfiguring alarm settings as appropriate, or for gathering additional information regarding the alarm event. For multiple simultaneous alarm events, a plurality of alarm messages may be prioritized for a clinician on a designated area of the user interface. Prioritization may be communicated via the presentation of a combination of icons, alerts, text, or otherwise, on individual alarm messages. Additionally or alternatively, prioritization may be communicated based on the graphical placement of alarm messages relative to other alarm messages, for instance by displaying more serious alarm messages above other alarm messages, or by displaying more recent alarm messages above other alarm messages. Additionally or alternatively, alarm messages may be partially translucent, such that other displayed respiratory data may be simultaneously viewed with the alarm messages.

Embodiments of the present application provide a graphical user interface for displaying one or more informative alarm messages corresponding to an alarm event. The graphical user interface may comprise at least one window associated with the graphical user interface and one or more elements within the at least one window comprising at least one summary alarm message element for communicating a brief description of the alarm event. The at least one summary alarm message element may further comprise an icon communicating a priority of the alarm event. The at least one summary alarm message may also comprises an element for selectively expanding the at least one summary alarm message element to display a detailed alarm message element. A detailed alarm message element may communicate additional information regarding the alarm event and may be translucent such that respiratory data presented in the at least one window may be simultaneously viewable with the detailed alarm message element. When the at least one window comprises two or more summary alarm message elements, the two or more summary alarm message elements may be displayed in an order along a border of the at least window for communicating a priority of each of the two or more summary alarm message elements. Additionally, the detailed alarm message element may further comprise a hyperlink for providing access to one or more parameter display screens or one or more alarm settings screens associated with the alarm event.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 is a diagram illustrating an embodiment of an exemplary ventilator connected to a human patient.

FIG. 2 is a block-diagram illustrating an embodiment of a ventilatory system having a graphical user interface for displaying structured and informative alarms.

FIG. 3 is an illustration of an embodiment of a graphical user interface displaying a first summary level of a structured alarm.

FIG. 4 is an illustration of an embodiment of a graphical user interface displaying a second detailed level of a structured alarm.

FIG. 5 is an illustration of an embodiment of a graphical user interface displaying a plurality of summary level alarm messages associated with a plurality of alarm events and a single detailed level alarm message associated with the single alarm event.

### DETAILED DESCRIPTION

Although the techniques introduced above and discussed in detail below may be implemented for a variety of medical devices, the present disclosure will discuss the implementation of these techniques for use in a mechanical ventilator system. The reader will understand that the technology described in the context of a ventilator system could be adapted for use with other therapeutic equipment having graphical user interfaces for displaying alarms.

This disclosure describes systems and methods for optimizing the informative presentation of alarms on a ventilator user interface. Specifically, embodiments may provide a first level of display that conveys a summary of an alarm event and may provide access to a discretionary second level of display that conveys additional detailed information regarding the alarm event. Further embodiments may, inter alia, provide access, via a hyperlink or otherwise, to settings and/or display screens for resetting the alarm following clinician intervention, for reconfiguring alarm settings as appropriate, or for gathering additional information regarding the alarm event. The first and second levels of alarm display may be provided as message tabs, dialog boxes, message banners, message flags, or other method of appropriate visual display. Additional embodiments may provide alarm messages with different icons or alerts, corresponding to a relative gravity, status, or priority of the alarm event. Multiple alarm messages may be provided in a prioritized order such that clinicians may readily identify high priority alarm messages among a plurality of alarm, messages. Additionally or alternatively, alarm indicators may be partially translucent, such that other displayed respiratory data may be simultaneously viewed with alarm messages.

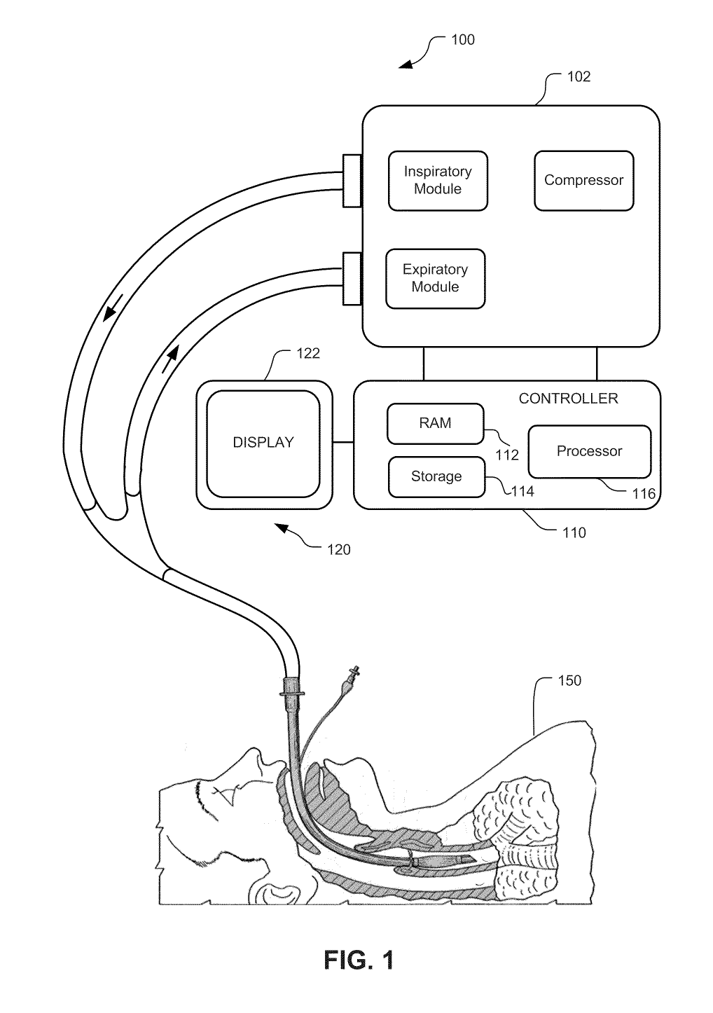

FIG. 1 illustrates an embodiment of a ventilator 100 connected to a human patient 150. Ventilator 100 includes a pneumatic system 102 (also referred to as a pressure generating system 102) for circulating breathing gases to and from patient 150 via a ventilation tubing system, which couples the patient to the pneumatic system via an invasive patient interface.

The pneumatic system 102 may include a variety of other components, including sources for pressurized air and/or oxygen, mixing modules, valves, sensors, tubing, accumulators, filters, etc. Controller 110 is operatively coupled with pneumatic system 102, signal measurement and acquisition systems, and an operator interface 120 that may enable an operator to interact with the ventilator 100. Controller 110 may include memory 112, one or more processors 116, storage 114, and/or other components of the type commonly found in command and control computing devices.

The memory 112 is computer-readable storage media that stores software that is executed by the processor 116 and which controls the operation of the ventilator 100. In an embodiment, the memory 112 includes one or more solid-state storage devices such as flash memory chips. In an alternative embodiment, the memory 112 may be mass storage connected to the processor 116 through a mass storage controller (not shown) and a communications bus (not shown). In the depicted example, operator interface 120 includes a display 122 that is touch-sensitive, enabling the display to serve both as an input and output device.

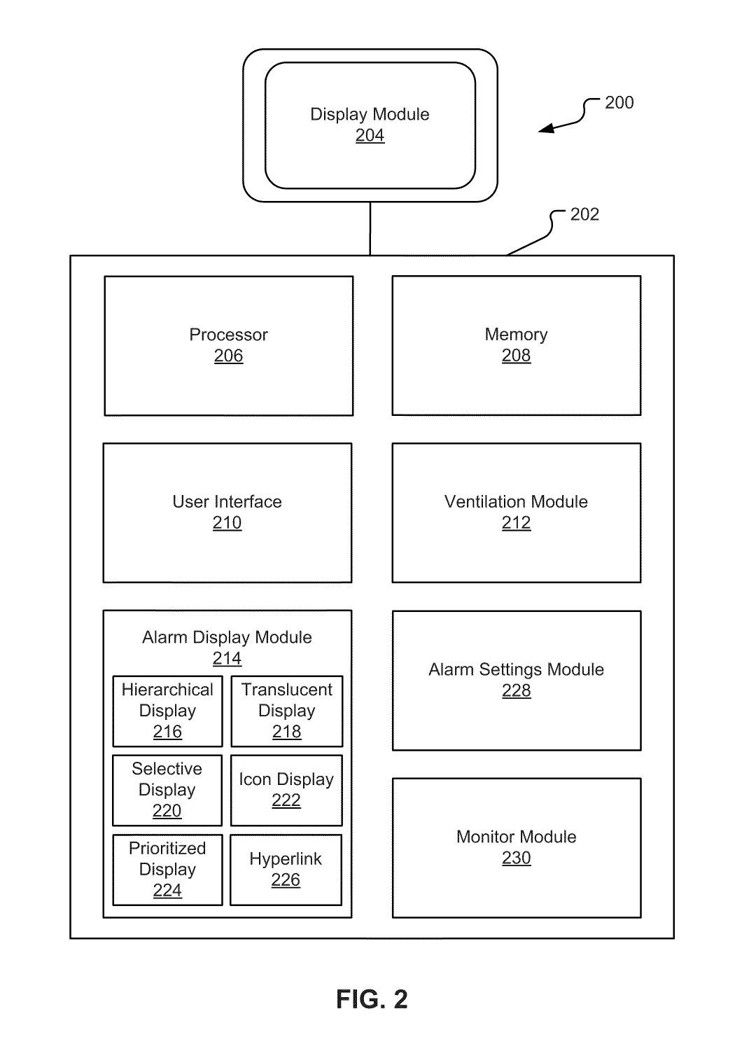

FIG. 2 is a block-diagram illustrating an embodiment of a ventilatory system 200 having a graphical user interface for displaying structured and informative alarms.

The ventilator 202 includes a display module 204, memory 208, one or more processors 206, user interface 210, and ventilation module 212. Memory 208 is defined as described above for memory 112. Similarly, the one or more processors 206 are defined as described above for the one or more processors 116. Ventilation module 212 may oversee ventilation as delivered to a patient according to the ventilatory settings prescribed for the patient. For example, ventilation module 212 may deliver pressure and/or volume into a ventilatory circuit, and thereby into a patient's lungs, by any suitable method, either currently known or disclosed in the future.

The display module 204 presents various input screens and displays to a clinician, including but not limited to one or more structured alarm displays, as will be described further herein, for receiving clinician input and for displaying useful clinical data and alerts to the clinician. The display module 204 is further configured to communicate with user interface 210. The display module 204 may provide various windows and elements to the clinician for input and interface command operations. Additionally, user interface 210 may accept commands and input through display module 204 and may provide useful alarm information to the clinician through display module 204. Display module 204 may further be an interactive display, whereby the clinician may both receive and communicate information to the ventilator 202, as by a touch-activated display screen. Alternatively, user interface 210 may provide other suitable means of communication with the ventilator 202, for instance by a keyboard or other suitable interactive device.

Alarm display module 214 may be useful for providing comprehensive alarm information and access to alarm settings and data on a graphical user interface (GUI) of the ventilator, as may be provided by display module 204. Specifically, a hierarchical alarm structure may be provided in which a summarized alarm message may be initially presented and, upon clinician selection, an additional detailed alarm message may be displayed. The summarized alarm message may further provide comprehensive information to the clinician in abbreviated form, for example the seriousness of an alarm message may be communicated via various icons and exclamation indicators and the priority of the alarm message vis-à-vis other alarm messages may be communicated via the relative graphical placement of the alarm message.

Additionally, a summary and/or detailed alarm message may provide immediate access to the display and/or settings screens associated with an alarm event. For example, an associated alarm settings screen may be accessed from an alarm message via a hyperlink such that the clinician may reset the alarm and/or may reconfigure alarm conditions as necessary. An associated parameter display screen may also be accessed such that the clinician may view clinical data associated with the alarm event in the form of charts, graphs, or otherwise. In this way, the clinician may access additional information regarding irregular respiratory parameters, irregular patient vital signs, or faulty machine operation that caused the alarm event.

In order to accomplish the various aspects of the hierarchical informative alarm display, the alarm display module 214 may communicate with various other components and/or modules. For instance, an alarm settings module 228 may be provided. Alarm settings module 228 may monitor the various settings and other input provided by a clinician to the ventilator via the user interface 210 or display module 204. Alarm settings module 228 may compare and evaluate parameter settings entered by the clinician according to any suitable method or procedure. For example, alarm settings module 228 may detect when patient settings are missing or otherwise inappropriate for a particular input field. Inappropriate parameter settings may be indicated where settings entered for different parameters are inconsistent, e.g., one parameter setting indicates that the patient is a child, while another parameter setting indicates that the patient is an adult male, etc. In addition, alarm settings module 228 may evaluate parameter data received from monitor module 230 against the settings associated with the monitored parameters. When alarm settings module 228 determines that the parameter data falls outside applicable settings and ranges, alarm settings module 228 may communicate with alarm display module 214, or other modules of the alarm display module 214, in order to generate an informative alarm message.

Alarm display module 214 may also be configured with a hierarchical display module 216. The hierarchical display module 216 may be in communication with the monitor module 230 and/or alarm settings module 228 to receive an indication that an alarm event has occurred. The hierarchical display module 216 may be responsible for generating a multi-level alarm message via any suitable means. For example, a first level summary alarm message may be provided as a tab, banner, dialog box, or other similar type of display. Further, a summary alarm messages may be provided along a border of the graphical user interface that is either blank or that displays minimally important information. The shape and size of the summary alarm message may also be optimized for easy viewing with minimal interference. The summary alarm message may be further configured with a combination of icons and text such that the clinician may readily identify the priority of the alarm message.

Hierarchical display module 216 may be preconfigured with various summary messages or alarm descriptions corresponding to each general type of alarm event. General summary messages may also be preconfigured to provide abbreviated information to a clinician. For example, when a pressure reading indicates that the peak pressure setting has been breached, an abbreviated summary message may be displayed: “↑Pₚₑₐₖ.” This abbreviated summary message may provide both an indication that a high limit was breached, i.e. by the ↑ indicator, and an abbreviated indication of the particular breached parameter, i.e. by the Pₚₑₐₖ notation. The same general summary message may also include explanatory information regarding the particular breach, for instance: “↑Pₚₑₐₖ—High Inspiratory Pressure.” In general, a summary level alarm message may be provided in any suitable position on the screen, by any suitable means, such that a general description of an alarm event and/or its gravity may be efficiently communicated to a clinician.

The hierarchical display module 216 may also generate a selectively accessed second level alarm message. The second level alarm message may provide additional details and information regarding the alarm event and may be accessible from the first level summary alarm message. Second level alarm messages may be preconfigured with a detailed alarm message or description corresponding to various types of alarm events. For example, a detailed alarm message may provide possible reasons for an alarm breach, suggested checks or procedures for mitigating the alarm, or other helpful information. Additionally, other embodiments may provide for semi-custom detailed alarm messages. For instance, portions of a detailed alarm message may be preconfigured for similar types of alarm events, while other portions may provide variable fields that may be populated with more specific information regarding a particular breach, for instance the extent that a parameter was breached, the number of breaths over which the breach occurred, whether a maximum or minimum parameter setting was breached, etc.

Alarm display module 214 may also be configured with a translucent display module 218. Translucent display module 218 may allow for display of the summary alarm message and/or the detailed alarm message such that displayed respiratory data may be visualized behind the alarm message. This feature may be particularly useful for displaying the expanded detailed alarm message. As described previously, alarm messages may be displayed in areas of the display screen that are either blank or that cause minimal distraction from the respiratory data and other graphical representations provided by the GUI. However, upon selective expansion of a detailed alarm message, respiratory data and graphs may be at least partially obscured. As a result, translucent display module 218 may provide the detailed alarm message such that it is partially transparent. Thus, graphical and other data may be visible behind the detailed alarm message.

Alarm display module 214 may also be configured with a selective display module 220. As discussed above, a detailed alarm message may be selectively displayed in order to offer additional information or details regarding an alarm event to a clinician. According to some embodiments, the second level detailed alarm message may be activated by clicking on the first level display message, touching a portion of the message, or otherwise. Additionally or alternatively, the first level summary alarm message may provide an arrow, or some other feature or icon for selection or activation of the detailed alarm message. Thus, a general summary alarm message may expand upon selection to provide a detailed alarm message. The detailed alarm message may be provided as a tab, banner, dialog box, or other similar type of display, which may extend from behind the general summary alarm message upon selection. In addition, according to some embodiments, the detailed alarm message may be condensed upon selection of an arrow, or some other feature or icon, via touching, clicking, or otherwise. Upon clearing or otherwise resetting an alarm following an alarm event, the summary alarm message and the detailed alarm message may also be cleared from the graphical user interface.

Alarm display module 214 may also be configured with an icon display module 222. Icon display module 222 may provide various icons and other identifiers that may communicate additional abbreviated information to a clinician, for instance regarding the seriousness or priority of an alarm message. For instance, “!!!” may be represented in a corner, or other visible area, of the general summary message and may indicate that the alarm is relatively serious, while “!!” or “!” may indicate that the alarm is less serious. In other embodiments, a number, letter, or other priority icon may be provided to communicate the priority of an alarm message vis-à-vis other displayed alarm messages. In still other embodiments, a status icon may be provided such that the status of an alarm message may be communicated, for instance, an active status or an inactive status, a high or low status, etc. Status may also refer to the number of times during a time period that the same alarm has occurred. In still other embodiments, an up-arrow, e.g.,“↑,” or a down-arrow, e.g., “↓,” may be provided to communicate whether a high or low limit was breached, respectively. Indeed, any number or combination of icons or other indicators may be employed to communicate additional, abbreviated information to a clinician.

Alarm display module 214 may also be configured with a prioritized display module 224.

As noted above, multiple alarm messages may occur at the same or similar time. In this case, it may be useful for the clinician to readily determine which alarm messages are of higher priority and should be addressed more quickly. Alternatively, it may be useful for the clinician to readily identify an order in which alarm messages occurred. The present disclosure provides for presentation of one or more pending alarms in a vertical array, for example, that may convey an alarm priority and/or status. According to some embodiments, higher priority alarms may be presented above other alarm messages. In alternative embodiments, a most recent alarm message may occur above other alarm messages. Thus, based on a graphical placement of alarm messages relative to other alarm messages, additional information regarding the priority or status of alarms relative to other alarms may be communicated to a clinician.

Alarm display module 214 may also be configured with a hyperlink module 226. Hyperlink module 226 may be configured to provide access from the various hierarchical alarm messages to various settings and display screens associated with an identified alarm event. For example, an icon or other link indicator may be provided in either the summary alarm message and/or the detailed alarm message that may be activated or otherwise selected. Upon selection, the icon may provide direct access, via a hyperlink or otherwise, to associated settings or display screens corresponding to a particular alarm event. When access to a settings screen is provided, the clinician may reset the alarm following clinician intervention or may reconfigure alarm settings as appropriate. When access to a display screen is provided, the clinician may view additional information and respiratory data regarding the alarm event. Hyperlink module 226 may further provide access to any useful display screen, settings screen, or other graphical user interface available on the ventilator that is associated with a particular alarm event.

Monitor module 230 may operate to monitor the physical condition of the patient in conjunction with the proper operation of the ventilator 202. The monitor module 230 may communicate with display module 204, user interface 210, alarm display module 214, or other suitable modules or processors of the ventilator 202. Specifically, monitor module 230 may communicate with alarm display module 214 and/or display module 204 such that information regarding alarm events may be displayed to the clinician. Monitor module 230 may further utilize one or more sensors to detect changes in various physiological or mechanical parameters. Indeed, any sensory or derivative technique for monitoring the physical condition of the patient or the mechanical operation of the ventilator may be employed in accordance with embodiments described herein.

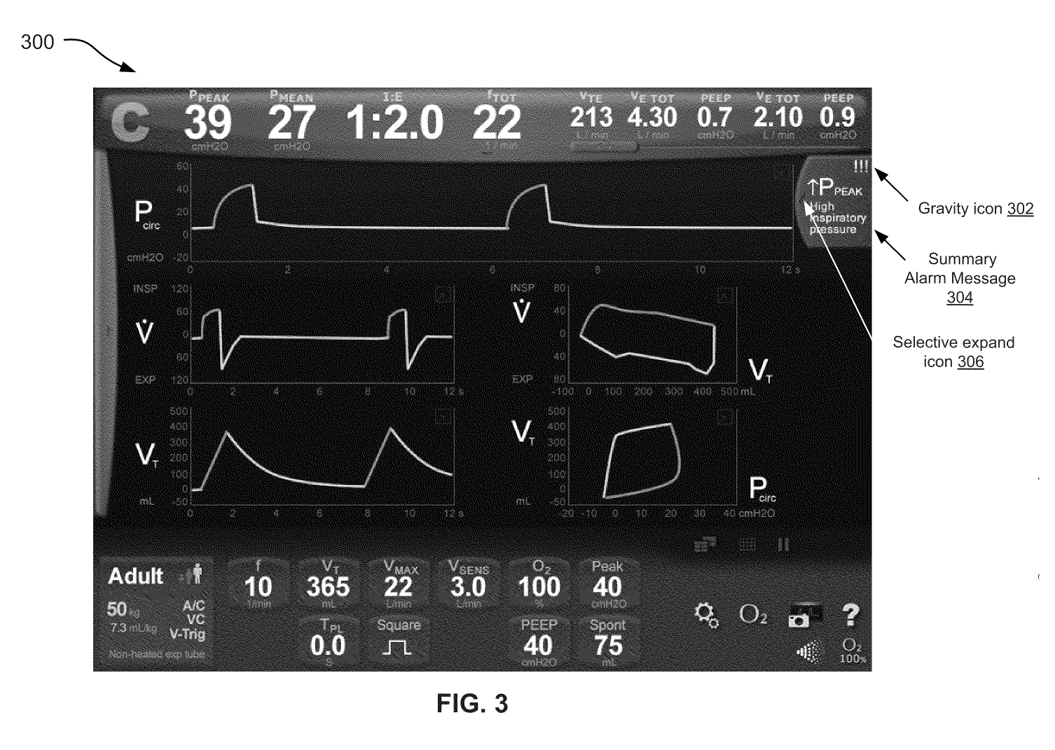

FIG. 3 is an illustration of an embodiment of a graphical user interface 300 displaying a first summary level of a structured alarm. Specifically, FIG. 3 illustrates an embodiment of a graphical user interface displaying a summary alarm message for a high inspiratory pressure error.

For example, a summary alarm message 304 may be generated in response to the ventilator detecting a high pressure error. Summary alarm message may provide an abbreviated notation, e.g., “↑Pₚₑₐₖ,” as well as a brief textual message, e.g., “High Inspiratory Pressure.” As described previously, the inclusion of the “↑” icon indicates that a maximum pressure limit was breached. Note that summary alarm message 304 is presented in a location of the display that is blank such that none of the displayed respiratory or other data is obscured by the alarm message. According to the illustrated embodiment, a gravity icon 302, or other alert, may also be displayed. Gravity icon 302 indicates a relative seriousness of a particular alarm event. In the illustrated embodiment, the gravity icon 302 indicates that the high pressure error is serious by presenting three exclamation marks, i.e.,“!!!,” in the upper right-hand corner of the summary alarm message. Gravity icon 302 may be provided in any position on the summary alarm message, and/or the corresponding detailed alarm message, such that the relative seriousness of an alarm event is plainly communicated to a clinician. In addition, gravity icon 302 may present any other visual indication to identify the severity of a particular alarm, for instance, by increasing a number and height of a series of “bars” to indicate increasingly serious alarm events, or by successively shading slices of a pie graph icon to indicate increasingly serious alarm events.

According to other embodiments, another icon, such as a priority icon, may be presented such that a priority order of alarm messages may be displayed. The order of the messages may be associated with a temporal indicator or with an indication of the order in which alarm messages ought to be addressed. For example, priority icon may be provided as a number or a letter. According to still other embodiments, a status icon may be provided such that the status of an alarm message may be communicated, as described above.

A selective expand icon 306 may also be provided, such as the arrow icon, [symbol] displayed in the illustrated embodiment. As described above, by touching, clicking, or otherwise selecting the selective expand icon 306, a clinician may expand the alarm message to display a detailed alarm message. Thus, a detailed alarm message may be activated only if and when a clinician desires additional information regarding an alarm event.

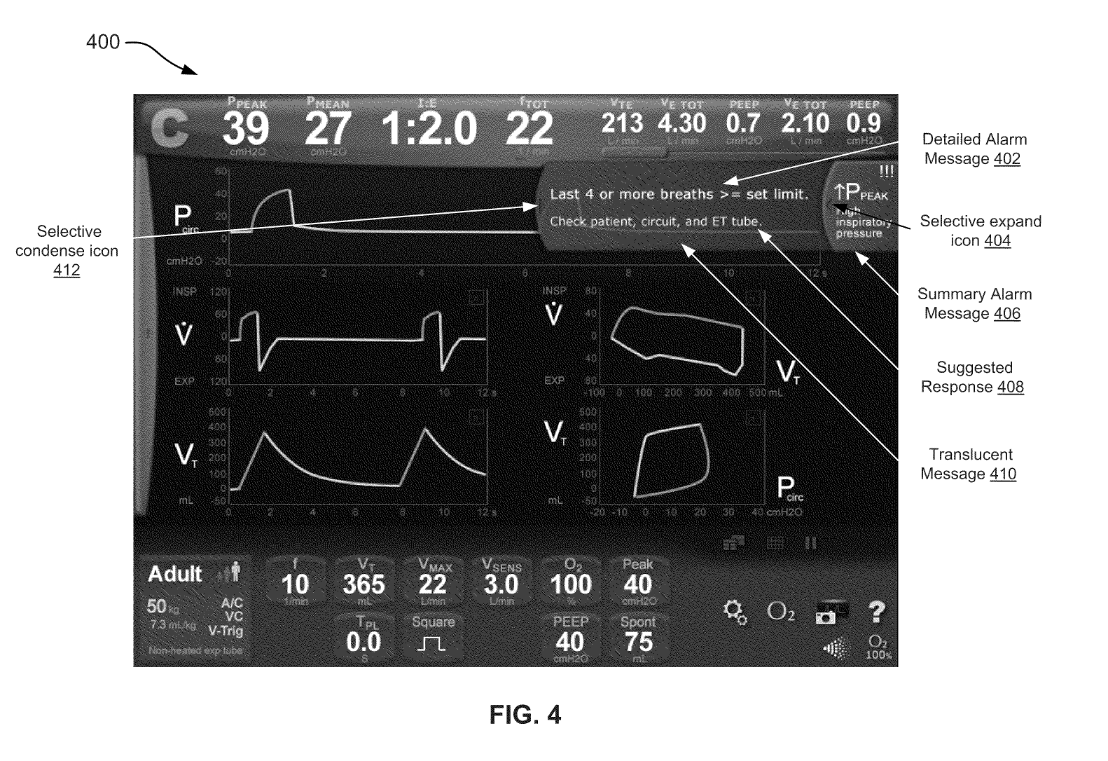

FIG. 4 is an illustration of an embodiment of a graphical user interface 400 displaying a second informative level of a structured alarm. Specifically, FIG. 4 provides an embodiment of a graphical user interface displaying a second informative level of the high inspiratory pressure error described in FIG. 3.

Graphical user interface 400 may display a detailed alarm message 402. As described above, detailed alarm message 402 may be provided upon activation or selection of summary alarm message 406. As further described above, detailed alarm message 402 may be expanded from a summary “high inspiratory pressure” message by clicking or touching a selective expand icon 404, or other selective element. Detailed alarm message 402 may provide more specific information regarding the alarm event, for instance: “Last 4 or more breaths>=set limit.” Detailed alarm message 402 may also provide possible reasons for the alarm event, suggested checks or procedures for mitigating the alarm, or other helpful information. For example, with reference to the above-described pressure error, the detailed alarm message 402 may further provide a suggested response 408, i.e., “Check patient, circuit, and ET tube.”

In addition, as described previously, detailed alarm message 402 may provide access to the particular ventilatory display or settings screen(s) applicable to the alarm event. As such, the clinician may immediately respond to an alarm in an intuitive and convenient manner. Access to additional associated screen(s) may be provided according to any suitable link or other means (not shown). Upon responding to an alarm event, the clinician may reset the alarm and the summary and detailed alarm messages may be cleared from the graphical user interface.

Detailed alarm message 402 may also be displayed as a translucent message 410. As illustrated, graphical data associated with the P_{circ} waveform may be visualized behind detailed alarm message 402. Indeed, in the illustrated embodiment, a clinician may easily identify the inspiratory and the expiratory phase of a single breath behind detailed alarm message 402.

A selective condense icon 412 may also be provided, such as the arrow icon, [symbol] displayed in the illustrated embodiment. Selective condense icon 412 may be activated via click, touch, or otherwise to hide the detailed alarm message 402 behind summary alarm message 406. In alternative embodiments, selective condense icon 412 may be activated to hide both the summary and the detailed alarm messages, for example condensing both alarm messages into a thin alarm banner displaying only a selective expand icon 404.

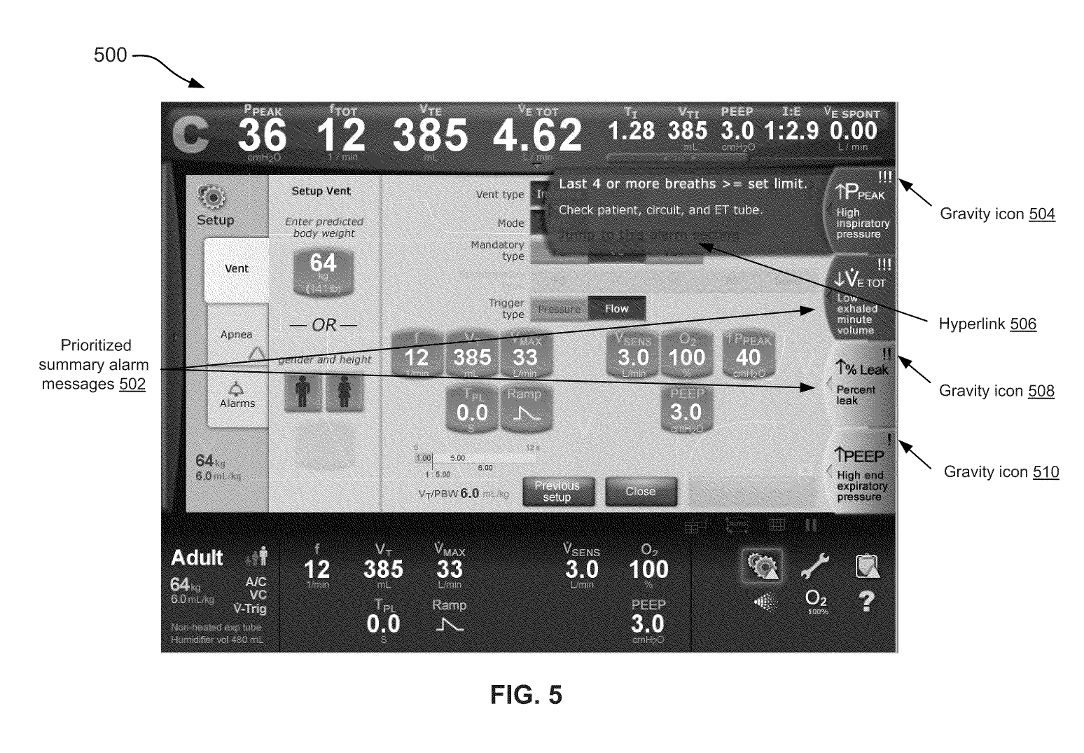

FIG. 5 is an illustration of an embodiment of a graphical user interface 500 displaying a plurality of summary level alarm messages associated with a plurality of alarm events and a single detailed level alarm message associated with a single alarm event.

Specifically, graphical user interface 500 displays a plurality of summary alarm messages. For example, a top-most summary alarm message refers to a high inspiratory pressure error, abbreviated, “↑Pₚₑₐₖ,” as discussed above. The top-most summary alarm message also displays a gravity icon 504 in the upper right-hand corner, i.e. “!!!”

In addition, referring to the illustrated summary alarm messages represented along the border of graphical user interface 500, the summary alarm messages may be provided as prioritized summary alarm messages 502. That is, the summary alarm messages may be ordered to communicate additional information to a clinician. According to some embodiments, summary alarm messages may be ordered such that the summary alarm message corresponding to the most recent alarm event is represented above other summary alarm messages. In the alternative, the most recent summary alarm message may be provided below other summary alarm messages. According to other embodiments, as illustrated in FIG. 5, summary alarm messages corresponding to more serious alarm events may be presented above other summary alarm messages. For example, the illustrated “High inspiratory pressure” summary alarm message is presented above the “Percent leak” summary alarm message, which is presented above the “High end expiratory pressure” summary alarm message.

According to the illustrated embodiment, the “High inspiratory pressure” summary alarm message is presented in red with a gravity icon 504 of “!!!” and the “Low exhaled minute volume” summary alarm message is also provided in red with a “!!!” gravity icon. Thus, when “High inspiratory pressure” and “Low exhaled minute volume” summary alarm messages are prioritized according to their relative gravity they may be presented in either the first or the second positions. Alternatively, they may be prioritized temporally, perhaps with the most recent alarm message placed in the first position (not shown). Again, referring to the illustrated embodiment, the “Percent leak” summary alarm message is presented in yellow with a gravity icon 508 of “!!”; and the “High end expiratory pressure” summary alarm message is presented in yellow with a gravity icon 510 of “!.” Thus, the “Percent leak” summary alarm message is displayed in a prioritized order above “High end expiratory pressure” summary alarm message, as gravity icon 508 indicates a higher relative gravity than gravity icon 510.

Additionally, according to the illustrated embodiment, hyperlink 506 is displayed as part of the detailed alarm message. In the present embodiment, hyperlink 506 provides direct access to the alarm settings screen associated with the high inspiratory pressure error indicated by the summary and detailed alarm messages. In alternative embodiments, hyperlink 506 may provide direct access to a parameter display screen associated with the pressure parameter, for example, a parameter display screen presenting a pressure waveform and/or a pressure-volume loop. Indeed, hyperlink 506 may provide direct access to any useful display and/or settings screen associated with the high inspiratory pressure alarm event.

As FIG. 5 illustrates, when multiple alarm events occur, displaying the summary alarm messages in a prioritized order enables a clinician to make informed decisions as to the order in which alarm events should be addressed. Further, direct access to associated display and settings windows for each alarm event enables a clinician to quickly and decisively address each alarm and then proceed to the next.

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the appended claims.

What is claimed is:

1. A graphical user interface for displaying one or more informative alarm messages corresponding to an alarm event, the ventilator configured with a computer having a user interface including the graphical user interface for accepting commands and for displaying information, the graphical user interface comprising:
at least one window associated with the graphical user interface; and
one or more elements within the at least one window comprising at least one summary alarm message element for communicating a brief description of the alarm event.

2. The graphical user interface of claim 1, wherein the at least one summary alarm message element is provided along a border of the graphical user interface.

3. The graphical user interface of claim 1, wherein the at least one summary alarm message element further comprises an icon communicating a priority of the alarm event.

4. The graphical user interface of claim 3, wherein the icon communicating a priority of the alarm event communicates a seriousness of the alarm event.

5. The graphical user interface of claim 1, wherein the at least one summary alarm message further comprises an element for selectively expanding the at least one summary alarm message element to display a detailed alarm message element.

6. The graphical user interface of claim 5, wherein the element for selectively expanding the at least one summary alarm message element is an arrow icon.

7. The graphical user interface of claim 5, wherein the detailed alarm message element expands from behind the at least one summary alarm message element.

8. The graphical user interface of claim 5, wherein the detailed alarm message element communicates additional information regarding the alarm event.

9. The graphical user interface of claim 5, wherein the detailed alarm message element is translucent such that respiratory data presented in the at least one window is simultaneously viewable with the detailed alarm message element.

10. The graphical user interface of claim 1, wherein the one or more elements within the at least one window comprise two or more summary alarm message elements.

11. The graphical user interface of claim 10, wherein the two or more summary alarm message elements are displayed in an order along a border of the at least window for communicating a priority of each of the two or more summary alarm message elements.

12. The graphical user interface of claim 5, wherein the detailed alarm message element further comprises:
a hyperlink for providing access to one or more parameter display screens associated with the alarm event.

13. The graphical user interface of claim 5, wherein the detailed alarm message element further comprises:
a hyperlink for providing access to one or more alarm settings screens associated with the alarm event.

14. The graphical user interface of claim 5, wherein the detailed alarm message element further comprises an element for selectively hiding the detailed alarm message element.

15. The graphical user interface of claim 14, wherein the element for selectively hiding the detailed alarm message element is an arrow icon.

16. The graphical user interface of claim 5, wherein upon resetting an alarm, the summary alarm message element and the detailed alarm message element are automatically removed from the graphical user interface.

17. A computer-readable storage medium having instructions that when executed provide a graphical user interface for displaying one or more informative alarm messages corresponding to an alarm event, the graphical user interface comprising:
at least one window associated with the graphical user interface; and
one or more elements within the at least one window including at least one summary alarm message element for communicating a brief description of the alarm event.

18. The computer-readable storage medium of claim 17, wherein the at least one summary alarm message further comprises an element for selectively expanding the at least one summary alarm message element to display a detailed alarm message element.

19. A ventilatory system for providing a graphical user interface for displaying one or more informative alarm messages corresponding to an alarm event, comprising:
at least one display device;
at least one processor; and
at least one memory, communicatively coupled to the at least one processor and containing instructions that, when executed by the at least one processor, provide a graphical user interface on the at least one display, comprising:
at least one window associated with the graphical user interface; and
one or more elements within the at least one window including at least one summary alarm message element for communicating a brief description of the alarm event.

20. The ventilatory system of claim 19, wherein the at least one summary alarm message further comprises an element for selectively expanding the at least one summary alarm message element to display a detailed alarm message element.
